(19) United States
(12) Patent Application Publication
(10) Pub. No.: US 2026/0098954 A1
(43) Pub. Date: Apr. 9, 2026

(54) METHOD AND APPARATUS FOR TRACKING OBJECT LOCATION BASED ON ARTIFICIAL INTELLIGENCE

(71) Applicant: Research & Business Foundation SUNGKYUNKWAN UNIVERSITY, Suwon-si (KR)

(72) Inventors: Sung June BYUN, Suwon-si (KR); Ji Hoon SONG, Suwon-si (KR); Young Gun PU, Suwon-si (KR); Kang Yoon LEE, Seoul (KR)

(73) Assignee: Research & Business Foundation SUNGKYUNKWAN UNIVERSITY, Suwon-si (KR)

(21) Appl. No.: 18/955,859

(22) Filed: Nov. 21, 2024

(30) Foreign Application Priority Data
Oct. 4, 2024 (KR) 10-2024-0135174

(51) Int. Cl. G01S 13/48; G01S 13/66

(52) U.S. Cl. CPC G01S 13/48; G01S 13/66

(57) ABSTRACT

A method of tracking an object location based on beamforming according to an embodiment of the present disclosure may include, in a first scan mode for determining presence or absence of an object, determining a first angle change vector of a beam for scanning a three-dimensional space, scanning the three-dimensional space while changing at least one of an azimuth angle and an elevation angle at which the beam is radiated in the three-dimensional space based on the first angle change vector, constructing a first data set for input into an object tracking model based on a first received signal generated by reflection of the beam, and inputting the first data set into the object tracking model and obtaining object presence or absence information based on first output data of the object tracking model.

### CROSS-REFERENCE TO RELATED APPLICATION

This application claims priority to and the benefit of Korean Patent Application No. 10-2024-0135174, filed on October 4, 2024, the disclosure of which is incorporated herein by reference in its entirety.

### BACKGROUND

### 1. Field of the Invention

The present disclosure relates to a method and apparatus for tracking an object location based on beamforming.

### 2. Discussion of Related Art

Beamforming is a technology that focuses a wireless signal in a specific direction through an antenna array. Beamforming technology can provide higher signal strength and transmission efficiency by focusing signals in a desired direction using multiple antennas.

Beamforming technology can play an important role in wireless communication, improving signal quality and extending a communication range. For example, in the field of network communication, beamforming technology is being developed as an optimization strategy in a direction that can reduce overhead.

In the present disclosure, a method in which beamforming technology can be used for object detection and object tracking is disclosed.

The background technology described above is technical information that the inventor possessed for deriving the present invention or acquired in a process of deriving the present invention and cannot necessarily be said to be publicly known technology disclosed to the general public prior to the filing of the application of the present invention.

### SUMMARY OF THE INVENTION

The present disclosure is directed to providing a method and apparatus for tracking an object location based on beamforming. The problem to be solved by the present invention is not limited to the problem mentioned above, and other problems and advantages of the present invention that are not mentioned can be understood from the following description, and will be more clearly understood from embodiments of the present invention. In addition, it will be understood that the problems to be solved by the present invention and advantages thereof can be realized by the means and combinations thereof stated in the claims.

According to a first aspect of the present disclosure, there is provided a method of tracking an object location based on beamforming, including, in a first scan mode for determining presence or absence of an object, determining a first angle change vector of a beam for scanning a three-dimensional space, scanning the three-dimensional space while changing at least one of an azimuth angle and an elevation angle at which the beam is radiated in the three-dimensional space based on the first angle change vector, constructing a first data set for input into an object tracking model based on a first received signal generated by reflection of the beam, and inputting the first data set into the object tracking model and obtaining object presence or absence information based on first output data of the object tracking model.

In the first aspect, the object tracking model may include a model that predicts an object location based on the first data set and stores an azimuth angle and an elevation angle corresponding to the predicted object location as a criterion azimuth angle and a criterion elevation angle.

In the first aspect, the method may further include setting the criterion azimuth angle and the criterion elevation angle as the origin and setting an operating mode to a second scan mode for tracking a location of the object in a surrounding space of the origin.

In the first aspect, the method may further include, in the second scan mode, determining a second angle change vector of the beam for scanning the surrounding space using the object tracking model, scanning the surrounding space while changing at least one of the criterion azimuth angle and the criterion elevation angle at which the beam is radiated based on the second angle change vector, constructing a second data set for input into the object tracking model based on a second received signal generated by reflection of the beam and the first output data, and inputting the second data set into the object tracking model and obtaining object location information based on second output data of the object tracking model.

According to a second aspect of the present disclosure, there is provided an apparatus for tracking an object location based on beamforming, including at least one memory, and at least one processor, in which the processor is configured to, in a first scan mode for determining the presence or absence of an object, determine a first angle change vector of a beam for scanning a three-dimensional space, scan the three-dimensional space while fixing one of an azimuth angle and an elevation angle at which the beam is radiated in the three-dimensional space and changing the other based on the first angle change vector, construct a first data set for input into an object tracking model based on a first received signal generated by reflection of the beam, and input the first data set into the object tracking model and obtain object presence or absence information based on first output data of the object tracking model.

In the second aspect, the object tracking model may include a model that predicts an object location based on the first data set and stores an azimuth angle and an elevation angle corresponding to the predicted object location as a criterion azimuth angle and a criterion elevation angle.

In the second aspect, the processor may be configured to set the criterion azimuth angle and the criterion elevation angle as the origin, and set an operating mode to a second scan mode for tracking a location of the object in a surrounding space of the origin

In the second aspect, the processor may be configured to, in the second scan mode, determine a second angle change vector of the beam for scanning the surrounding space using the object tracking model, scan the surrounding space while fixing one of the criterion azimuth angle and the criterion elevation angle at which the beam is radiated and changing the other based on the second angle change vector, construct a second data set for input into the object tracking model based on a second received signal generated by reflection of the beam and the first output data , and input the second data set into the object tracking model and obtain object location information based on second output data of the object tracking model.

According to a third aspect of the present disclosure, there is provided a computer-readable recording medium on which a program for causing the method according to the first aspect to be executed by a computer is recorded.

In addition, other methods and other systems for implementing the present invention, and computer-readable recording media storing a computer program for causing the above method to be executed may be further provided.

Aspects, features, and advantages other than those described above will become apparent from the following drawings, claims, and detailed description of the invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram for describing a method of tracking an object based on beamforming according to an embodiment of the present disclosure;

FIG. 2 is a block diagram for describing an example of an internal configuration of an apparatus for tracking an object according to an embodiment of the present disclosure;

FIG. 3 is a flowchart for schematically describing a method of tracking an object based on beamforming according to an embodiment of the present disclosure;

FIG. 4 is a flowchart for describing a first scan mode according to an embodiment of the present disclosure;

FIG. 5 is a diagram for describing a method of scanning a space using a beam according to an embodiment of the present disclosure;

FIG. 6 is a diagram for describing a first data set and first output data regarding an object tracking model according to an embodiment of the present disclosure;

FIG. 7 is a flowchart for describing a second scan mode according to an embodiment of the present disclosure;

FIG. 8 is a diagram for describing a second data set and second output data regarding an object tracking model according to an embodiment of the present disclosure;

FIG. 9 is a flowchart for describing an example of a method of tracking an object based on beamforming according to an embodiment of the present disclosure; and

FIG. 10 is a flowchart for describing another example of a method of tracking an object based on beamforming according to an embodiment of the present disclosure.

### DETAILED DESCRIPTION OF EXEMPLARY EMBODIMENTS

The advantages and features of the present invention, and the methods for achieving them, will become clear with reference to embodiments described in detail with the accompanying drawings. However, it should be understood that the present invention is not limited to embodiments presented below but may be implemented in various different forms and includes all transformations, equivalents, and substitutes included in the spirit and technical scope of the present invention. The embodiments presented below are provided to make the disclosure of the present invention complete and to fully inform those skilled in the art to which the present invention pertains of the scope of the invention. In describing the present invention, when it is determined that a specific description of related known technologies may obscure the gist of the present invention, the detailed description thereof will be omitted.

Terms used in this application are only used to describe specific embodiments, and are not intended to limit the present invention. Singular expressions include plural expressions unless the context clearly indicates otherwise. In this application, it should be understood that the terms “include” or “have” are intended to designate the presence of features, numbers, steps, operations, components, parts, or combinations thereof described in the specification, but do not preclude the possibility of the presence or addition of one or more other features numbers, steps, operations, components, parts, or combinations thereof.

Some embodiments of the present disclosure may be represented by functional block configurations and various processing operations. Some or all of these functional blocks may be implemented by various numbers of hardware and/or software configurations that execute specific functions. For example, the functional blocks of the present disclosure may be implemented by one or more microprocessors or by circuit configurations for a given function. In addition, for example, the functional blocks of the present disclosure may be implemented by various programming or scripting languages. The functional blocks may be implemented by algorithms that run on one or more processors. In addition, the present disclosure may adopt conventional techniques for electronic environment settings, signal processing, and/or data processing. Terms such as “mechanism,” “element,” “means,” and “configuration” may be used broadly and are not limited to mechanical and physical configurations.

In addition, connecting lines or connecting members between components illustrated in the drawings are only illustrative of functional connections and/or physical or circuit connections. In an actual apparatus, connections between components may be represented by various functional connections, physical connections, or circuit connections that are replaceable or added.

Hereinafter, embodiments will be described in detail with reference to the accompanying drawings. However, the embodiments may be implemented in various different forms and are not limited to the examples described herein.

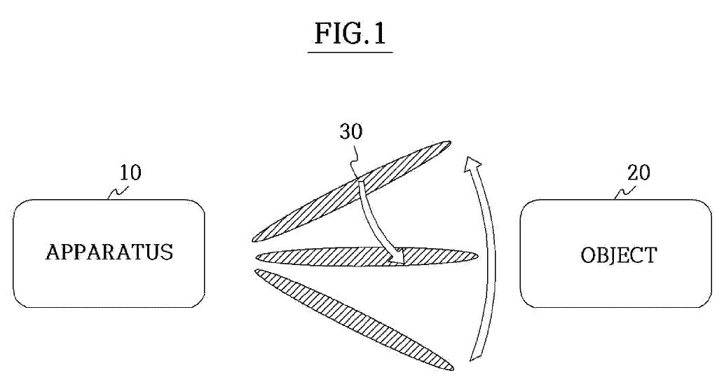

FIG. 1 is a conceptual diagram for describing a method of tracking an object based on beamforming according to an embodiment of the present disclosure.

In the present disclosure, an apparatus 10 may be a component that may track a location of an object 20 using beamforming technology. For example, referring to FIG. 1, the apparatus 10 may radiate a beam into a three-dimensional space and track the location of the object 20 using received beam information.

In an embodiment, the apparatus 10 may be an apparatus that is mounted on a transportation device and may track the location of an object in real time while moving together with the transportation device. Examples of the transportation device on which the apparatus 10 is mounted may include a land transportation device such as an automobile, a truck, etc., a maritime transportation device such as a ship, a submarine, etc., and an aerial transportation device such as an aircraft, a helicopter, a drone, etc. In the present disclosure, the transportation device on which the apparatus 10 may be mounted is not limited to the examples described above.

Meanwhile, the apparatus 10 may include a plurality of antennas that may implement beamforming technology. For example, the apparatus 10 may include an antenna array composed of a plurality of antennas. Each antenna included in the antenna array may independently transmit or receive a signal. The apparatus 10 may combine signals from each antenna and focus the signals in a specific direction. Meanwhile, components that may be included in the apparatus 10, in addition to the antenna array, will be described below.

In an embodiment of the present disclosure, the apparatus 10 and the object 20 may be defined as a transmitting device that transmits a specific signal and a receiving device that receives the signal transmitted by the transmitting device, respectively. For example, the apparatus 10 may be an electronic device of a first user, and the object 20 may be an electronic device of a second user. The user’s electronic device may be, but is not limited to, a smart phone, a notebook PC, a desktop PC, a laptop, a tablet computer, etc.

Meanwhile, a signal transmitted and received between the apparatus 10 and the object 20 and a signal forming a beam may be the same or different in type, but may be clearly distinguished in role. For example, types of the signal transmitted and received between the apparatus 10 and the object 20 and the signal forming the beam may not be limited to any one of analog signals, digital signals, waveform signals, carrier signals, direct current signals, alternating current signals, pulse signals, radio signals, bit stream signals, electromagnetic wave signals, acoustic signals, particle signals, energy signals, etc. However, the signal transmitted and received between the apparatus 10 and the object 20 is a signal for the role of information transfer, energy transfer, etc., whereas the signal forming the beam may be understood as a signal for a role of tracking the location of the object 20 before the apparatus 10 transmits the signal for the role (information transfer, energy transfer, etc.) to the object 20.

In the embodiment of the present disclosure, the apparatus 10 may scan a three-dimensional space using a beam. For example, the apparatus 10 may scan all or part of the three-dimensional space around the apparatus 10 while changing a point or region to which the beam is radiated in the three-dimensional space.

In an embodiment, the apparatus 10 may scan the three-dimensional space based on two operating modes of a first scan mode and a second scan mode. As an example, the first scan mode and the second scan mode may be distinguished by a range of a space being scanned. As another example, the first scan mode and the second scan mode may be distinguished by a period at which a point (or region) to which the beam is radiated is changed, an amount of change by which an angle at which the beam is radiated is adjusted, etc.

In another embodiment, the first scan mode and the second scan mode may be distinguished based on a purpose of scanning. For example, the first scan mode may be an operating mode for determining the presence or absence of an object, and the second scan mode may be an operating mode for tracking the location of the object. In another aspect, the first scan mode may be understood as an operating mode for quickly scanning a relatively wide three-dimensional space to determine whether an object is present in the three-dimensional space, and the second scan mode may be understood as an operating mode for finely scanning a relatively narrow three-dimensional space to continuously track the location of the object that is present in the three-dimensional space. More details will be described below.

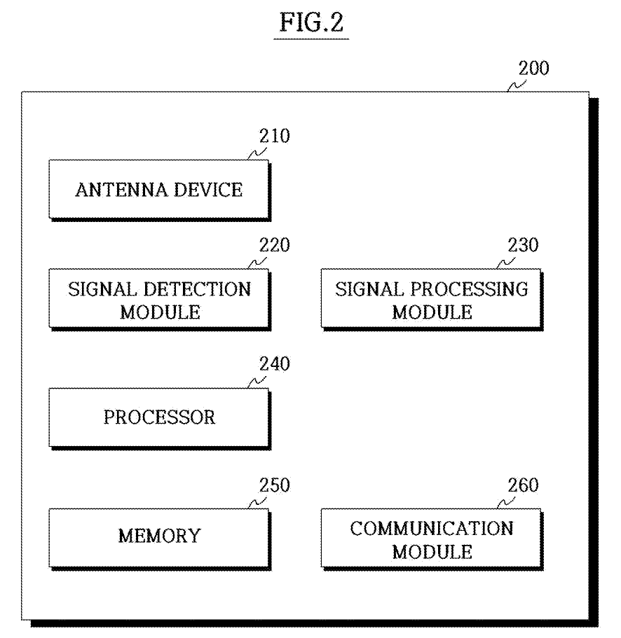

FIG. 2 is a block diagram for describing an example of an internal configuration of an apparatus for tracking an object according to an embodiment of the present disclosure. FIG. 2 may be understood as an example of a structure of the apparatus 10 of FIG. 1.

Referring to FIG. 2, an apparatus for tracking an object 200 according to an embodiment may include an antenna device 210, a signal detection module 220, a signal processing module 230, a processor 240, a memory 250, and a communication module 260. For convenience of description, only components related to the present invention are illustrated in FIG. 2. Therefore, in addition to the components illustrated in FIG. 2, other general-purpose components may be further included in the apparatus for tracking the object 200. In addition, it is obvious to a person having ordinary knowledge in the technical field related to the present invention that the components illustrated in FIG. 2 may be implemented as independent devices.

The antenna device 210 may include at least one antenna. For example, the antenna device 210 may be an array antenna including a plurality of antenna elements. For example, the antenna device 210 may include an array antenna having a one-dimensional or multi-dimensional structure. For example, the antenna device 210 may include an array antenna implemented in various forms such as a straight, flat, or circular shape. Each antenna included in the antenna device 210 may individually transmit or receive a signal. For example, the signals of each antenna may interfere with each other, causing the signals to be focused in a specific direction.

The signal detection module 220 may detect a beam signal and convert the detected signal into a form that may be processed by the signal processing module 230. For example, the signal detection module 220 may detect a radio frequency (RF) signal and convert the detected RF signal into a digital signal. For example, the beam signal may be provided from a separate receiving device or may be received through an antenna or array antenna physically connected to the signal detection module 220.

The signal processing module 230 may process a digital signal transmitted from the signal detection module 220 in real time. In an embodiment, the signal processing module 230 may determine the presence or absence of an object or track the location of the object based on the digital signal. In another embodiment, the signal processing module 230 may construct a data set for input into an object tracking model based on the digital signal. More details will be described below.

The processor 240 may be a component that controls the overall function of the apparatus for tracking the object 200. For example, the processor 240 may execute instructions of a computer program by performing basic arithmetic, logic, and input/output operations. Here, the instructions may be provided from the memory 250 or an external device.

In addition, the processor 240 may control the overall operation of other components included in the apparatus for tracking the object 200. For example, the processor 240 may control performing an operation of detecting a signal or performing an operation of converting a detected signal by the processor 240. As another example, the processor 240 may control performing an operation of processing a digital signal in real time by the signal processing module 230. That is, the processor 240 may perform some functions of the signal detection module 220 or the signal processing module 230 interchangeably with the signal detection module 220 or the signal processing module 230. In other words, at least some functions described as those of the signal detection module 220 or the signal processing module 230 may be performed by the processor 240, or at least some of the functions described as those of the processor 240 may be performed by the signal detection module 220 or the signal processing module 230. Therefore, the signal detection module 220 or the signal processing module 230 may be understood as a type of processor, and in this case, the signal detection module 220, the signal processing module 230, and the processor 240 may be implemented as at least one processor.

Meanwhile, in an embodiment, the processor 240 may adjust a phase of a signal output from each antenna constituting the antenna device 210. For example, the processor 240 may adjust the phase of the signal output from each antenna to form a beam in a specific direction and focus the signal in a desired direction. In another sense, the processor 240 may adjust a direction or angle at which the beam is radiated. For example, the processor 240 may adjust the direction of the beam based on a beamforming algorithm. For example, the processor 240 may compute the direction, phase, amplitude, etc. of the signal to be output from each antenna using the beamforming algorithm. For example, the processor 240 may generate a phase control signal for each antenna based on the computation result, and may transmit the phase control signal to each antenna.

In addition to the above-described operations, the processor 240 may control at least some of the operations of the apparatus for tracking the object 200 described in this specification.

Meanwhile, the processor 240 may be implemented as an array of a plurality of logic gates or implemented as a combination of a general-purpose microprocessor and a memory for storing a program that can be executed by the microprocessor. For example, the processor 240 may include a general purpose processor, a central processing unit (CPU), a microprocessor, a digital signal processor (DSP), a controller, a microcontroller, a state machine, etc. In some environments, the processor 240 may include an application specific integrated circuit (ASIC), a programmable logic device (PLD), a field programmable gate array (FPGA), etc. For example, the processor 240 may be a combination of processing devices, such as a combination of a digital signal processor (DSP) and a microprocessor, a combination of a plurality of microprocessors, a combination of one or more microprocessors coupled with a DSP core, or a combination of any other such components.

The memory 250 may include any non-transitory computer readable storage medium. As an example, the memory 250 may include a non-volatile permanent mass storage device such as a random access memory (RAM), a read only memory (ROM), a disk drive, a solid state drive (SSD), a flash memory, etc. As another example, the non-volatile permanent mass storage device such as a ROM, an SSD, a flash memory, a disk drive, etc. may be a separate permanent storage device distinct from the memory 250. In addition, the memory 250 may store an operating system (OS) and at least one program code (e.g., a code for the processor 240 to perform the operation described as being performed by the apparatus for tracking the object 200).

These software components may be loaded from a computer-readable recording medium separate from the memory 250. Such a separate computer-readable recording medium may be a recording medium that may be directly connected to the apparatus for tracking the object 200, and may include, for example, a computer-readable recording medium such as a floppy drive, a disk, a tape, a DVD/CD-ROM drive, a memory card, or the like. Alternatively, the software components may be loaded into the memory 250 via the communication module 260 rather than from a computer-readable recording medium. For example, at least one program may be loaded into the memory 250 based on a computer program (e.g., a computer program for the processor 240 to perform the operations described as being performed by the apparatus for tracking the object 200, etc.) that is installed by files provided by developers or a file distribution system that distributes installation files of applications via the communication module 260.

The communication module 260 may provide a configuration or function for the apparatus for tracking the object 200 to communicate with an external device (e.g., an external server or object 20) through a network. For example, control signals, instructions, data, etc. provided under the control of the processor 240 may be transmitted to a component included in the apparatus for tracking the object 200 or an external device through the communication module 260 and the network.

Meanwhile, in an embodiment, data collected to track the location of the object are not included in the data that the communication module 260 transmits and receives to and from the external server. In other words, the apparatus 10 may be an On-Device type location tracking apparatus that processes data related to object location tracking on the apparatus itself without transmitting the data to a cloud server or an external server. According to the embodiment, since the time required for communication with an external server may be saved, fast data processing is possible and the location of the object may be tracked in real time.

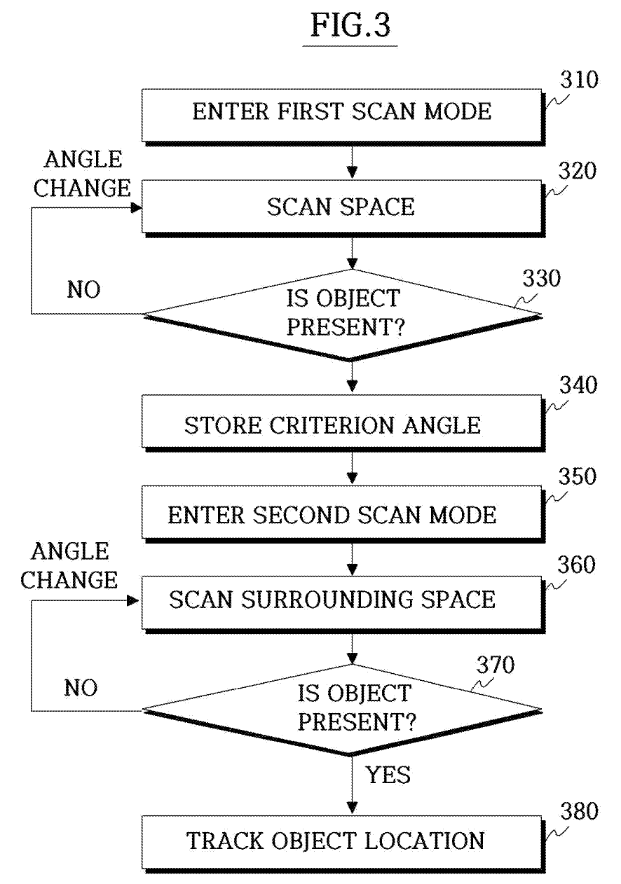

FIG. 3 is a flowchart for schematically describing a method of tracking an object based on beamforming according to an embodiment of the present disclosure.

Referring to FIG. 3, the method of tracking the object based on beamforming according to an embodiment of the present disclosure may include operations 310 to 380. Hereinafter, for convenience of description, the method of tracking the object based on beamforming will be described as being performed by the apparatus for tracking the object. It may be understood that the operations illustrated in FIG. 3 are executed by at least some of the components included in the above-described apparatus for tracking the object.

In operation 310, the apparatus for tracking the object may enter a first scan mode. For example, the first scan mode may be an operating mode for quickly scanning a wide range of space as described above to determine the presence or absence of an object in a three-dimensional space.

In an embodiment, the apparatus for tracking the object may enter the first scan mode in an initial state in which object location tracking is initiated. For example, the apparatus for tracking the object may enter the first scan mode in response to a type of object whose location is to be tracked being set. For example, the type of object may be set from among the user’s electronic devices as described above.

In another embodiment, the apparatus for tracking the object may enter the first scan mode again after tracking the location of a specific object according to a second scan mode which will be described below is finished. For example, the object that is a target of location tracking in the first scan mode that is started secondarily may be a different object from the target object in the first scan mode and the second scan mode that are performed primarily.

In an embodiment, the apparatus for tracking the object may determine an angle change vector of the beam in the first scan mode. Here, the angle change vector of the beam may be a value for expressing the magnitude by which an irradiation angle of the beam is adjusted and the direction in which the angle is adjusted, every predetermined period. For example, assuming that the space to which the beam is radiated changes every period T, the magnitude and direction of angle change between a beam radiated at T1 and a beam radiated at T2 may be referred to as the angle change vector. In other words, the apparatus for tracking the object may scan a three-dimensional space while changing the angle at which the beam is radiated every period T, and may determine a vector of the change in the angle at which the beam is radiated before scanning the space using the beam.

As an example, the magnitude and direction of the angle change of the beam may be constant. For example, when it is assumed that a period for scanning the three-dimensional space once is T, the direction of the angle change at which the beam is radiated during the period T may be constant, such as clockwise or counterclockwise. In addition, the amount of angle change of the beam during the period T may also be constant. For example, the apparatus for tracking the object may scan the three-dimensional space while changing the beam for scanning the three-dimensional space by 1 degree in a predetermined direction.

As another example, at least one of the magnitude and direction of the angle change of the beam may be dynamically varied. For example, the apparatus for tracking the object may set the angle change vector differently depending on the operating mode for scanning the three-dimensional space. In addition, the apparatus for tracking the object may change the angle change vector of the beam for each period of performing a scan according to the same operating mode, and further, even within a period of scanning the three-dimensional space once. For example, within the same period T, the amount of angle change between the beam radiated at T1 and the beam radiated at T2 and the amount of angle change between the beam radiated at T2 and the beam radiated at T3 may be different. Alternatively, the direction of the angle change between the beam radiated at T1 and the beam radiated at T2 and the direction of the angle change between the beam radiated at T2 and the beam radiated at T3 may be different.

Meanwhile, the above-described content regarding the angle change vector of the beam may be equally applied to the angle change vector of the beam in the second scan mode. More details will be described below.

In operation 320, the apparatus for tracking the object may scan the three-dimensional space while radiating the beam into the three-dimensional space.

In an embodiment, a scan range in the first scan mode may be set in advance. As an example, the apparatus for tracking the object may scan the entire region around the apparatus in the first scan mode.

As another example, the scan range in the first scan mode may be limited in advance. For example, the scan range in the first scan mode may be limited to a predetermined target region where an object is expected to be present. For example, the scan range in the first scan mode may be limited depending on the location of the apparatus for tracking the object (or the scan apparatus) in the three-dimensional world coordinate system. For example, when the apparatus for tracking the object is mounted on a drone and radiates a beam from the sky toward the ground to track the location of the object, the scan range in the first scan mode may be limited to a range below an elevation value of the apparatus for tracking the object in the world coordinate system.

In operation 330, the apparatus for tracking the object may obtain object presence or absence information based on a received signal generated by reflection of the beam.

In the present disclosure, the apparatus for tracking the object may obtain the object presence or absence information using a deep learning-based object tracking model or may obtain object location information using an object tracking model as will be described below. For example, the object tracking model may output the object presence or absence information or the object location information based on the received signal. Details will be described below.

In the present disclosure, “model” may mean a deep learning model based on an artificial neural network (ANN). The deep learning model has a deep structure with multiple hidden layers in the ANN and may learn complex patterns through this deep structure. For example, the deep learning model may be composed of an input layer, a hidden layer, and an output layer, and each layer may be composed of multiple neurons. In addition, each neuron may calculate an output value by applying a value obtained by multiplying an input value by a weight to an activation function, each layer may transmit a signal to the next layer, and the signal may be adjusted through the weight and bias. That is, the deep learning model optimizes the weight and bias using training data, and through this, the deep learning model may learn the complex relationship between an input and an output. Meanwhile, the deep learning model may be implemented as various types of models such as a multi-layer perceptron (MLP) model, a convolutional neural network (CNN) model, a recurrent neural network (RNN) model, etc. In addition, the deep learning model may be implemented as various models depending on a method of configuring the activation function, loss function, optimization algorithm, etc., and is not limited to a specific type of model.

In an embodiment, the object tracking model may include one or more artificial intelligence learning and inference models. For example, the object tracking model may be implemented as a model commonly used in deep learning as described above. For example, the object tracking model may be implemented as the RNN model, or as a long short-term memory (LSTM) model that is more suitable for processing sequence data. For example, as will be described below, the object tracking model may include a model that infers object presence or absence information, a model that infers object type information, a model that infers object location information, a model that predicts object movement paths, etc. However, the object tracking model is not limited thereto, and at least one model included in the object tracking model may be implemented as a multi-tasking model that infers a plurality of pieces of information from among the object presence or absence information, the object type information, and the object location information.

Meanwhile, the apparatus for tracking the object may repeatedly perform a scan process while adjusting the angle at which the beam is radiated based on the angle change vector described above when it is determined that an object is not present based on the received signal generated by reflection of the beam.

In contrast, in operation 340, the apparatus for tracking the object may store an angle of the beam corresponding to the beam reflected from the object as a criterion angle when it is determined that the object is present based on the received signal generated by reflection of the beam as a result of an operation according to the first scan mode.

For example, the apparatus for tracking the object may determine whether the object is present each time the apparatus for tracking the object receives a beam signal, and when it is determined that the object is present, the apparatus for tracking the object may store the angle at which the beam reflected from the object was radiated in real time. For example, the stored criterion angle may be used as a reference angle in the second scan mode.

In operation 350, the apparatus for tracking the object may enter the second scan mode. For example, the second scan mode may be an operating mode for tracking the location of the object by scanning a space in a narrower range than the scan range of the first scan mode as described above.

In an embodiment, the apparatus for tracking the object may set a condition for entering the second scan mode. The condition for entering the second scan mode may be related to first output data which will be described below. For example, the condition for entering the second scan mode may be satisfied depending on whether information, which indicates that an object is present, is present in the first output data. As another example, the condition for entering the second scan mode may be related to an operation history of the first scan mode. For example, the condition for entering the second scan mode may be satisfied depending on whether the apparatus for tracking the object has performed a scan for a predetermined number periods set in advance in the first scan mode.

In an embodiment, the apparatus for tracking the object may determine the angle change vector of the beam in the second scan mode. As described above, the above-described content regarding the angle change vector of the beam may be equally applied to the angle change vector of the beam in the second scan mode. More details will be described below.

In operation 360, the apparatus for tracking the object may scan the three-dimensional space while radiating the beam into the three-dimensional space. Here, the scan range in the second scan mode may be limited to a surrounding space, which is a partial region of the three-dimensional space.

For example, the scan range in the second scan mode may be set based on the criterion angle stored in operation 340. For example, the apparatus for tracking the object may set the coordinates to which the beam is directed as the origin and set a surrounding space of the set origin as the scan range in the second scan mode.

In an embodiment, the scan range in the second scan mode, that is, a range of the space around the origin, may be set according to a previously determined criterion. For example, the scan range in the second scan mode may be set to 1/2, 1/4, or the like of the scan range in the first scan mode.

In another embodiment, the range of the space around the origin may be set based on output data of the object tracking model in the first scan mode. For example, the first output data output by the object tracking model as an operation result in the first scan mode may include information estimating the type of the object, and the apparatus for tracking the object may set the scan range in the second scan mode according to the estimated type of the object. For example, the scan range in the second scan mode may be set to a different range when the type of the object is estimated to be a laptop and when the type of the object is estimated to be a mobile phone.

In operation 370, the apparatus for tracking the object may obtain object location information based on the received signal generated by reflection of the beam.

As described above, the apparatus for tracking the object may obtain the object location information using the deep-learning-based object tracking model even in the second scan mode. For example, the object tracking model may output the object location information based on the received signal. Details will be described below.

Meanwhile, when the apparatus for tracking the object determines that an object is not present based on the received signal generated by reflection of the beam, the apparatus for tracking the object may repeatedly perform the scan process while adjusting the angle at which the beam is radiated based on the angle change vector described above.

In contrast, in operation 380, the apparatus for tracking the object may track the location of the object while changing the angle at which the beam is radiated based on an expected movement path of the object when it is determined that the object is present based on the received signal generated by reflection of the beam as a result of the operation according to the second scan mode,

For example, the magnitude and direction of the angle change vector in the second scan mode may be set based on the output data of the object tracking model in the first scan mode. For example, the first output data output by the object tracking model as the result of the operation in the first scan mode may include information estimating the object type and information for predicting the object location, and the apparatus for tracking the object may set the magnitude of the angle change vector in the second scan mode according to the estimated object type and the direction of the angle change vector according to the predicted object location. More details will be described below.

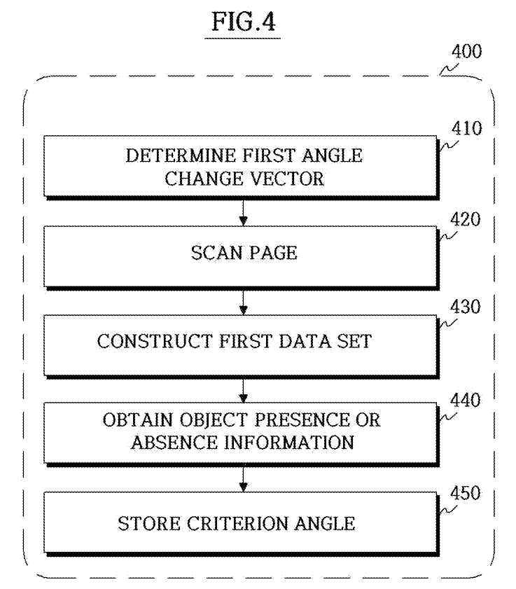

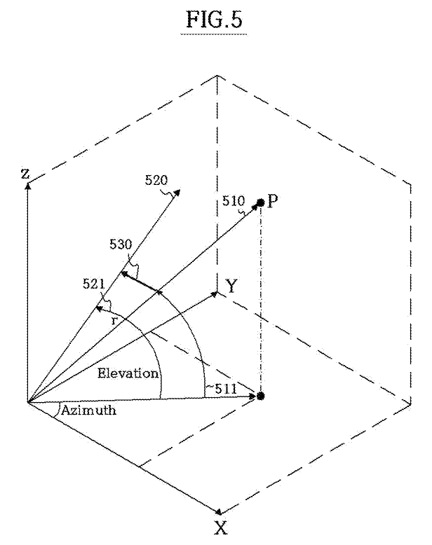

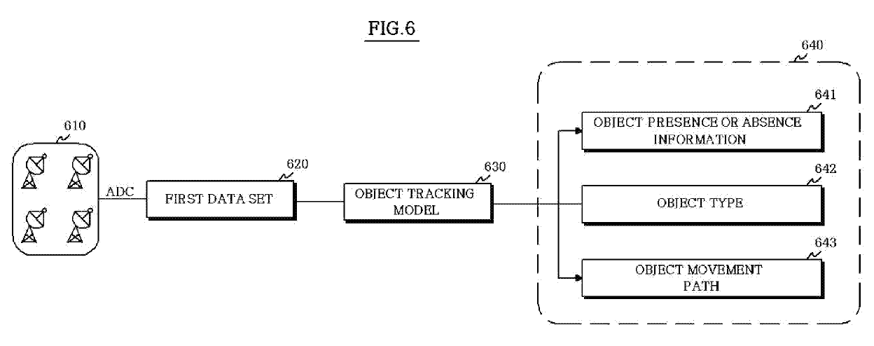

FIG. 4 is a flowchart for describing a first scan mode according to an embodiment of the present disclosure, FIG. 5 is a diagram for describing a method of scanning a space using a beam according to an embodiment of the present disclosure, and FIG. 6 is a diagram for describing a first data set and first output data regarding an object tracking model according to an embodiment of the present disclosure.

Referring to FIG. 4, an operation process 400 of the apparatus for tracking the object in the first scan mode according to an embodiment may include operations 410 to 450.

In operation 410, the apparatus for tracking the object may determine a first angle change vector in the first scan mode. For example, a direction of the first angle change vector may be the same for each scan period T in the first scan mode, or may be the same within the scan period T. For example, the direction in which the angle at which the beam is radiated in the first scan mode changes may be constant, such as counterclockwise or clockwise.

In an embodiment, the magnitude of the first angle change vector may be determined by combining a scan range in the first scan mode and a value which is set as a time (scan period) that may be taken to scan the scan range once. For example, when a range of each of an azimuth angle and elevation angle at which scanning should be performed in the first scan mode is set to 360 degrees, and the time it may take to scan a surface having the same azimuth angle (or elevation angle) while changing the elevation angle (or the azimuth angle) is set to 10T, the magnitude of the first angle change vector may be determined as 36 degrees/T.

In operation 420, the apparatus for tracking the object may scan a three-dimensional space while changing the angle at which the beam is radiated based on the first angle change vector.

For example, the apparatus for tracking the object may scan the three-dimensional space while changing at least one of the azimuth angle and elevation angle at which the beam is radiated in the three-dimensional space. For example, the apparatus for tracking the object may scan the three-dimensional space while fixing one of the azimuth angle and the elevation angle and changing the other based on the first angle change vector.

For example, referring to FIG. 5, the apparatus for tracking the object may maintain the azimuth angles of a first beam 510 radiated at T1 and second beam 520 radiated at T2 constant. In addition, the apparatus for tracking the object may determine an elevation angle 521 of the second beam 520 by combining an elevation angle 511 of the first beam 510 and an angle change vector 530.

In the above-described manner, the apparatus for tracking the object may perform a scan for the scan range in the first scan mode.

In the example illustrated in FIG. 5, the azimuth angle at which the beam is radiated is fixed and the elevation angle is adjusted according to the angle change vector, but they are not limited thereto. As described above, the azimuth angle and elevation angle at which the beam is radiated may be adjusted simultaneously according to the angle change vector.

Meanwhile, in an embodiment, the apparatus for tracking the object may adjust the phase of the signal output by each of the plurality of antennas forming the beam and change the azimuth angle or elevation angle at which the beam is radiated. In another sense, the apparatus for tracking the object may change the azimuth angle or elevation angle at which the beam is radiated based on a beam forming algorithm. In this disclosure, a specific description of the beam forming algorithm that changes the angle at which the beam is radiated is omitted. In other words, in order to radiate the beam in a specific direction (e.g., a specific elevation angle and a specific azimuth angle), a process of calculating the phase for the signal of individual antennas is omitted in the present disclosure.

Referring again to FIG. 4, in operation 430, the apparatus for tracking the object may construct the first data set for input into the object tracking model based on the first received signal generated by reflection of the beam.

Here, the first data set is input data input to the object tracking model, and may be understood as a data set used in a learning process or inference process of the object tracking model.

The first received signal is a signal reflected from the object, but signals received by each of the plurality of antennas may be different from each other. As will be described below, values obtained by converting the signals received by each of the plurality of antennas into digital signals may all be different.

The apparatus for tracking the object may perform digital conversion on the first received signal to construct the first data set. More specifically, the apparatus for tracking the object may convert signals received by the plurality of antennas into digital signals, and may construct the first data set by combining digital signals corresponding to each of the plurality of antennas. For example, the apparatus for tracking the object may construct a data set in the form of a 5×5 matrix corresponding to a 5×5 array antenna. Alternatively, the apparatus for tracking the object may construct the first data set in the form of sequence data by listing the digital signals corresponding to the array antennas.

As another example, the apparatus for tracking the object may construct a data set through a process of performing a preprocessing operation on digital signals corresponding to a plurality of antennas. For example, the data set may include the result obtained by performing a mean operation on digital signals corresponding to each antenna. Alternatively, the data set may be constructed to include a maximum value or minimum value among the digital signals corresponding to each antenna.

In an embodiment, the apparatus for tracking the object may assign a weight to each antenna (or a signal received by each antenna) and consider the assigned weight in the process of performing the preprocessing operation. For example, the apparatus for tracking the object may assign a weight to digital signals corresponding to some antennas, according to signal strength. In other words, the apparatus for tracking the object may construct a data set by combining the digital signal and signal strength of each antenna.

Meanwhile, the digital signal may be the result obtained by performing analog-to-digital-conversion (ADC) on the signal received by the antenna. For example, the digital signal may be bit data. For example, the size of the bit data may be set in advance by the user.

In operation 440, the apparatus for tracking the object may obtain object presence or absence information using the object tracking model. In this regard, a detailed description will be made with reference to FIG. 6.

For example, the apparatus for tracking the object may input a first data set 620 as input data to an object tracking model 630, and obtain object information based on first output data 640 of the object tracking model 630.

For example, the first data set 620 may be constructed using ADC data, which is the result obtained by converting the signal received by an array antenna 610 into a digital signal. For example, the object tracking model may be a model that receives the ADC data as input data and is trained to output the first output data 640 including presence-or-absence-of-object 641, etc. For example, the object tracking model may output the first output data 640 as indicating that an object is present when the ADC data is higher than a predetermined threshold, and that an object is not present when it is lower than the threshold. For example, when the ADC data is higher than a predetermined threshold, it may be estimated that an object is present in a region or at a point to which a beam corresponding to the ADC data is radiated.

Meanwhile, in an embodiment, the first output data 640 output by the object tracking model 630 may include the presence-or-absence-of-object 641, an object type 642, and an object movement path 643. Here, the first output data 640 is defined to refer to data output in the first scan mode and is only terminologically distinguished from second output data output in the second scan mode which will be described below, and the second output data may also include the presence-or-absence-of-object, the object type, and the object location.

In the embodiment, the object tracking model 630 may estimate an object type 642 based on the ADC data. For example, a plurality of thresholds for estimating the object type based on the ADC data may be set in advance. The object tracking model 630 may estimate the object type 642 by comparing the ADC data with the plurality of thresholds. For example, each threshold may be set differently depending on the type of the object. In addition, the threshold for estimating the type of the object and the threshold for estimating the presence or absence of the object may be set differently.

In another embodiment, the object tracking model 630 may predict the object movement path 643 based on the ADC data. The first data set 620 for predicting the object movement path 643 may be composed of a plurality of pieces of ADC data obtained at different time points. For example, when it is determined that an object is present based on the ADC data obtained at different time points, the object tracking model 630 may estimate that the same object has moved. In addition, the object tracking model 630 may predict the movement path 643 of the object based on the location of the object at different time points.

Referring again to FIG. 4, in operation 450, when the apparatus for tracking the object determines that the object is present in the three-dimensional space, the apparatus for tracking the object may store an angle corresponding to a beam reflected from the object as the criterion angle. For example, the apparatus for tracking the object may store the azimuth angle and elevation angle set at the time the beam with which the object has been identified was radiated as a criterion azimuth angle and a criterion elevation angle, respectively.

In an embodiment, the object tracking model may predict the object location based on the first data set. For example, as described above, the object tracking model may predict the object location based on the ADC data. The object tracking model may store the azimuth angle and elevation angle corresponding to the predicted object location as the criterion azimuth angle and criterion elevation angle, respectively.

The stored criterion azimuth angle and elevation angle may be the reference angles in the process of entering the second scan mode as described above.

For example, the apparatus for tracking the object may set the criterion azimuth angle and criterion elevation angle as the origin and set the operating mode to the second scan mode for tracking the location of the object in a surrounding space of the origin.

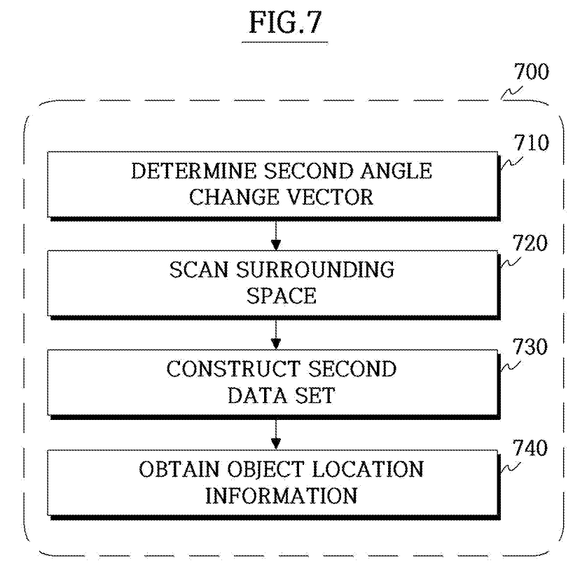

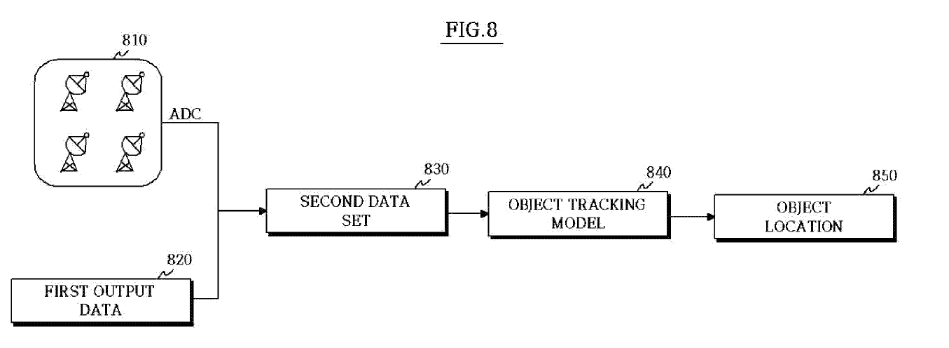

Hereinafter, the second scan mode will be described in detail with reference to FIGS. 7 and 8.

FIG. 7 is a flowchart for describing a second scan mode according to an embodiment of the present disclosure, and FIG. 8 is a diagram for describing a second data set and second output data regarding an object tracking model according to an embodiment of the present disclosure.

Referring to FIG. 7, an operation process 700 of the apparatus for tracking the object in the second scan mode according to an embodiment may include operations 710 to 740.

As described above, the apparatus for tracking the object may change the operating mode to the second scan mode based on the determination that an object is present in the first scan mode. The second scan mode may be understood as an operating mode for scanning the surrounding space of a specific point (or a specific region) set as the origin as described above.

Referring to FIG. 7, in operation 710, the apparatus for tracking the object may determine a second angle change vector of a beam in the second scan mode.

In an embodiment, the magnitude of the second angle change vector may be set to a smaller value than the magnitude of the first angle change vector. For example, the magnitude of the angle change vector may be set to correspond to a scan range in the scan mode. For example, since the scan range in the second scan mode may be set to a smaller range than the scan range in the first scan mode, the magnitude of the second angle change vector may be set to a smaller value than the magnitude of the first angle change vector.

In an embodiment, the apparatus for tracking the object may determine the second angle change vector using the object tracking model. For example, a model that outputs the second angle change vector may be implemented as a separate vector generation model. For example, a vector generation model may be included in the object tracking model. As another example, the object tracking model may be trained to output the second angle change vector. For example, tasks that the object tracking model may perform may include outputting the presence-or-absence-of-object, the object type, and the object movement path, as well as outputting an angle change vector.

Meanwhile, the object tracking model (in some embodiments, the vector generation model) may output the second angle change vector based on the first output data, which is a result in the first scan mode.

In an embodiment, the object tracking model may determine the magnitude of the second angle change vector based on the object type included in the first output data. For example, the type of the object may be estimated based on a result of scanning through the first scan mode, and accordingly, an approximate size of the object may be predicted. For example, since the scan range for performing the scan in the second scan mode may be set differently when the object is estimated to be a laptop and when the object is estimated to be a mobile phone, when it is assumed that scanning is performed at the same period, the magnitude of the second angle change vector may be determined differently depending on the type of the object.

In another embodiment, the object tracking model may determine a direction of the second angle change vector based on the object movement path included in the first output data. For example, the location of the object may be estimated as a result of scanning through the first scan mode, and the movement path of the object may be predicted. The object tracking model may determine the direction of the second angle change vector so that a scan is performed along the movement path of the object.

In operation 720, the apparatus for tracking the object may scan the surrounding space while changing the angle at which the beam is radiated based on the second angle change vector.

For example, the apparatus for tracking the object may scan a three-dimensional space while changing at least one of the azimuth angle and elevation angle at which the beam is radiated in the three-dimensional space. For example, the apparatus for tracking the object may scan the surrounding space while fixing one of the azimuth angle and elevation angle and changing the other based on the second angle change vector.

Meanwhile, the method described above with reference to FIG. 5 may also be applied when the apparatus for tracking the object performs a scan in the second scan mode.

In operation 730, the apparatus for tracking the object may construct a second data set for input into the object tracking model based on a second received signal generated by reflection of the beam.

The second data set is input data input into the object tracking model, and may be understood as a data set used in a learning process or inference process of the object tracking model.

The second received signal is a signal reflected from the object, but the signals received by each of a plurality of antennas may be different from each other. Accordingly, as will be described below, values obtained by converting the signals received by each of the plurality of antennas into digital signals may all be different.

The apparatus for tracking the object may perform digital conversion on the second received signal to construct the second data set. More specifically, the apparatus for tracking the object may convert signals received by the plurality of antennas into digital signals, and may construct the second data set by combining digital signals corresponding to each of the plurality of antennas. For example, the apparatus for tracking the object may construct the second data set in the form of a 5×5 matrix corresponding to a 5×5 array antenna. Alternatively, the apparatus for tracking the object may construct the second data set in the form of sequence data by listing the digital signals corresponding to the array antennas.

As another example, the apparatus for tracking the object may construct a data set through a process of performing a preprocessing operation on digital signals corresponding to a plurality of antennas. For example, the data set may include the result obtained by performing a mean operation on digital signals corresponding to each antenna. Alternatively, the data set may be constructed to include a maximum or minimum value among the digital signals corresponding to each antenna.

In an embodiment, the apparatus for tracking the object may assign a weight to each antenna (or the signal received by each antenna) and consider the assigned weight in the process of performing the preprocessing operation. For example, the apparatus for tracking the object may assign a weight to digital signals corresponding to some antennas, according to signal strength. In other words, the apparatus for tracking the object may construct a data set by combining the digital signal and signal strength of each antenna.

Meanwhile, the digital signal may be the result obtained by performing the ADC on the signal received by the antenna. For example, the digital signal may be bit data. For example, the size of the bit data may be set in advance by the user.

In an embodiment, the apparatus for tracking the object may construct the second data set by combining the second received signal and the first output data.

For example, the object tracking model may output object location information based on the second received signal included in the second data set and may refer to the first output data. More details will be described below.

In operation 740, the apparatus for tracking the object may obtain object location information using the object tracking model. In this regard, a detailed description will be made with reference to FIG. 8.

For example, the apparatus for tracking the object may input a second data set 830 as input data to an object tracking model 840 and obtain an object location 850 included in the second output data of the object tracking model 840.

The second data set 830 may be constructed using ADC data, which is a result obtained by converting the signal received by an array antenna 810 into a digital signal. For example, the object tracking model may be a model that receives ADC data as input data and is trained to output second output data including the object location 850. For example, the object tracking model may output the second output data as indicating that an object is present when the ADC data is higher than a predetermined threshold, and that an object is not present when it is lower than the threshold. For example, when the ADC data is higher than a predetermined threshold, it may be estimated that an object is present in a region or at a point to which a beam corresponding to the ADC data is radiated.

In an embodiment, the scan range in the second scan mode may be set narrowly based on the type of the estimated object, and the scan direction may be set to follow an expected movement path of the object according to the second angle change vector. Accordingly, continuous scanning of the object may be possible in the second scan mode, and the object location 850 may be tracked.

Meanwhile, in an embodiment, a second threshold set for the object tracking model to output the second output data may be set to a different value from a first threshold set to output the first output data. For example, when it may be estimated that an object is present at a given point only when the ADC data is higher than a predetermined threshold as in the example described above, the second threshold may be set to a higher value than the first threshold. In other words, in the second scan mode, the object tracking model may output output data based on a more strictly set threshold.

In an embodiment, referring to FIG. 8, the second data set 830 may be constructed to include first output data 820. For example, the first output data 820 may be used as reference data. For example, without being limited to what is shown in FIG. 8, the second output data may include, in addition to the object location 850, the presence-or-absence-of-object, the object type, etc., similar to the first output data. For example, the object tracking model 840 may infer information about an object based on the second received signal (or ADC data corresponding to the second received signal), and may verify the second output data using the first output data as reference data. For example, the object tracking model 840 may readjust a threshold for outputting the second output data based on the first output data included in the second data set. In another sense, the object tracking model 840 may readjust the second threshold based on the first output data during the process of verifying the second output data, or may perform retraining of the model when the verification result for the second output data is different from the first output data.

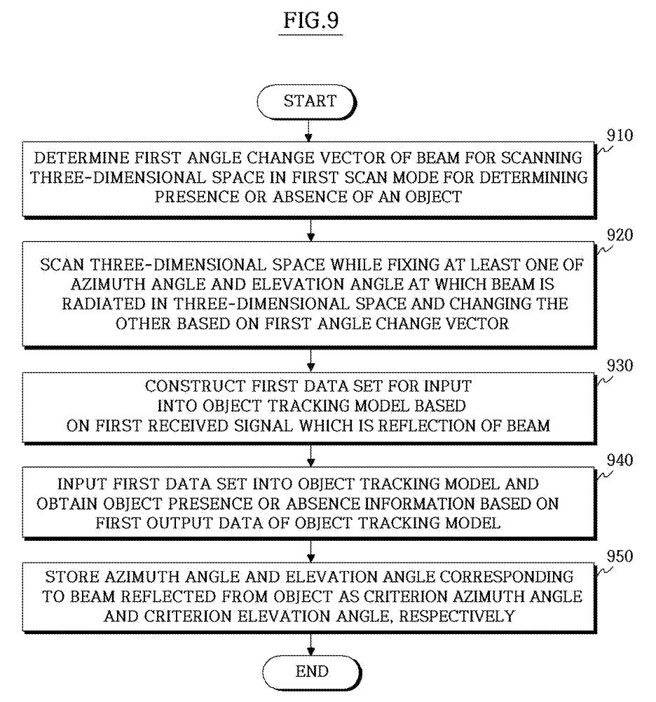

FIG. 9 is a flowchart for describing an example of a method of tracking an object based on beamforming according to an embodiment of the present disclosure.

A method of tracking an object while operating in a first scan mode by an apparatus for tracking an object according to an embodiment of the present disclosure will be described with reference to FIG. 9. As illustrated in FIG. 9, an operating method of the apparatus for tracking the object according to the first scan mode according to an embodiment may include operations 910 to 950. Meanwhile, it may be understood that the operations illustrated in FIG. 9 are executed by at least some of the components included in the above-described apparatus for tracking the object. In addition, even when not included in the operations illustrated in FIG. 9, at least some of the operations described above as being performed by the apparatus for tracking the object may be included in the operating method according to the first scan mode.

In operation 910, the apparatus for tracking the object may determine a first angle change vector of a beam for scanning a three-dimensional space in a first scan mode for determining the presence or absence of an object.

In an embodiment, a scan range in the first scan mode may be limited according to a location in a three-dimensional world coordinate system.

In operation 920, the apparatus for tracking the object may scan the three-dimensional space while changing at least one of an azimuth angle and elevation angle at which the beam is radiated in the three-dimensional space based on a first angle change vector.

In an embodiment, the apparatus for tracking the object may adjust a phase of a signal output from each of the plurality of antennas forming the beam and change the azimuth angle or elevation angle at which the beam is radiated based on the first angle change vector.

In operation 930, the apparatus for tracking the object may construct a first data set for input into the object tracking model based on a first received signal generated by reflection of the beam.

In an embodiment, the apparatus for tracking the object may convert the first received signal received by a plurality of antennas forming a beam into a digital signal, and construct a first data set by combining digital signals corresponding to each of the plurality of antennas.

In operation 940, the apparatus for tracking the object may input the first data set into an object tracking model and obtain object presence or absence information based on first output data of the object tracking model.

In an embodiment, the object tracking model may include a model for estimating an object type based on the first data set.

In an embodiment, the object tracking model may output the object presence or absence information based on at least one piece of bit data included in the first data set.

In an embodiment, the object tracking model may include a model for predicting an object location based on the first data set. In addition, the object tracking model may include a model for storing the azimuth angle and elevation angle corresponding to the predicted object location as a criterion azimuth angle and a criterion elevation angle, respectively.

In operation 950, when it is determined that an object is present in the three-dimensional space, the apparatus for tracking the object may store the azimuth angle and elevation angle corresponding to the beam reflected from the object as the criterion azimuth angle and the criterion elevation angle, respectively.

In an embodiment, the apparatus for tracking the object may set the criterion azimuth angle and the criterion elevation angle as the origin and set an operating mode to a second scan mode for tracking a location of the object in a surrounding space of the origin.

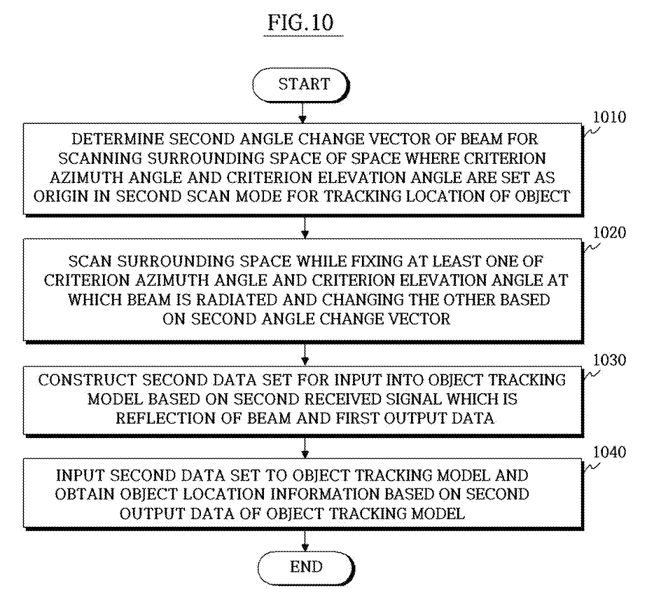

FIG. 10 is a flowchart for describing another example of a method of tracking an object based on beamforming according to an embodiment of the present disclosure.

A method of tracking an object while operating in a second scan mode by the apparatus for tracking the object according to an embodiment of the present disclosure will be described with reference to FIG. 10. As illustrated in FIG. 10, an operating method of the apparatus for tracking the object according to the second scan mode according to an embodiment may include operations 1010 to 1040. Meanwhile, it may be understood that the operations illustrated in FIG. 10 are executed by at least some of the components included in the above-described apparatus for tracking the object. In addition, even when not included in the operations illustrated in FIG. 10, at least some of the operations described above as being performed by the apparatus for tracking the object may be included in the operating method according to the second scan mode.

In operation 1010, the apparatus for tracking the object may determine a second angle change vector of a beam for scanning a surrounding space of a space where the criterion azimuth angle and the criterion elevation angle are set as the origin in the second scan mode for tracking the location of an object.

In an embodiment, the magnitude of the second angle change vector may be a smaller value than the magnitude of the first angle change vector.

In an embodiment, the apparatus for tracking the object may determine the second angle change vector of the beam in the second scan mode for scanning the surrounding space using the object tracking model.

For example, the apparatus for tracking the object may determine the size of the second angle change vector based on the object type included in the first output data.

For example, the apparatus for tracking the object may determine a direction of the second angle change vector based on the object movement path included in the first output data.

In operation 1020, the apparatus for tracking the object may scan the surrounding space while changing at least one of the criterion azimuth angle and the criterion elevation angle at which the beam is radiated based on the second angle change vector.

In an embodiment, the apparatus for tracking the object may adjust a phase of the signal output by each of the plurality of antennas forming the beam and change the criterion azimuth angle or the criterion elevation angle at which the beam is radiated based on the second angle change vector.

In operation 1030, the apparatus for tracking the object may construct a second data set for input into the object tracking model based on a second received signal generated by reflection of the beam and the first output data.

In an embodiment, the apparatus for tracking the object may convert the second received signal received by the plurality of antennas forming the beam into a digital signal and construct the second data set by combining the digital signals corresponding to each of the plurality of antennas.

In operation 1040, the apparatus for tracking the object may input the second data set to the object tracking model and obtain object location information based on the second output data of the object tracking model.

In an embodiment, the object tracking model may output the object location information based on at least one piece of bit data included in the second data set.

According to an embodiment of the present disclosure, it is possible to identify the location of an object using beamforming technology.

In addition, according to an embodiment of the present disclosure, it is possible to easily determine the location of a device for receiving a signal before a device for transmitting a signal transmits the signal.

As long as there is no explicit description of the order of operations constituting the method according to the present invention or description to the contrary, the operations may be performed in any appropriate order. The present invention is not necessarily limited to the described order of the operations. The use of all examples or all exemplary terms (e.g., “etc.”) in the present invention is simply for describing the present invention in detail, and the scope of the present invention is not limited by such examples or exemplary terms unless so limited by the claims. In addition, those skilled in the art will recognize that various modifications, combinations, and changes may be made according to design conditions and factors within the scope of the appended claims or their equivalents.

Therefore, the idea of the present invention should not be limited to the embodiments described above, and not only the claims described below but also all scopes equivalent to or equivalently modified from the claims fall within the scope of the idea of the present invention.

What is claimed is:

1. A method of tracking an object location based on beamforming, comprising:
in a first scan mode for determining presence or absence of an object,
determining a first angle change vector of a beam for scanning a three-dimensional space;
scanning the three-dimensional space while changing at least one of an azimuth angle and an elevation angle at which the beam is radiated in the three-dimensional space based on the first angle change vector;
constructing a first data set for input into an object tracking model based on a first received signal generated by reflection of the beam; and
inputting the first data set into the object tracking model and obtaining object presence or absence information based on first output data of the object tracking model.

2. The method of claim 1, wherein the constructing of the first data set includes:
converting the first received signal received by a plurality of antennas forming the beam into a digital signal; and
combining the digital signals corresponding to each of the plurality of antennas to form the first data set.

3. The method of claim 1, wherein the object tracking model includes a model that estimates an object type based on the first data set.

4. The method of claim 1, wherein the object tracking model includes a model that predicts an object location based on the first data set and stores an azimuth angle and an elevation angle corresponding to the predicted object location as a criterion azimuth angle and a criterion elevation angle.

5. The method of claim 4, further comprising:
setting the criterion azimuth angle and the criterion elevation angle as the origin; and
setting an operating mode to a second scan mode for tracking a location of the object in a surrounding space of the origin.

6. The method of claim 5, further comprising:
determining a second angle change vector of the beam in the second scan mode for scanning the surrounding space using the object tracking model;
scanning the surrounding space while changing at least one of the criterion azimuth angle and the criterion elevation angle at which the beam is radiated based on the second angle change vector;
constructing a second data set for input into the object tracking model based on a second received signal generated by reflection of the beam and the first output data; and
inputting the second data set into the object tracking model and obtaining object location information based on second output data of the object tracking model.

7. The method of claim 6, wherein the determining includes determining a magnitude of the second angle change vector based on an object type included in the first output data.

8. The method of claim 6, wherein the determining includes determining a direction of the second angle change vector based on an object movement path included in the first output data.

9. The method of claim 6, wherein a magnitude of the second angle change vector is a smaller value than a magnitude of the first angle change vector.

10. The method of claim 6, wherein the constructing of the second data set includes:
converting the second received signal received by a plurality of antennas forming the beam into a digital signal; and
combining the digital signals corresponding to each of the plurality of antennas to form the second data set.

11. The method of claim 6, wherein the object tracking model includes a model that outputs the object presence or absence information based on at least one piece of bit data included in the first data set and outputs the object location information based on at least one piece of bit data included in the second data set.

12. An apparatus for tracking an object location based on beamforming, comprising:
at least one memory; and
at least one processor,
wherein the processor is configured to:
in a first scan mode for determining presence or absence of an object,
determine a first angle change vector of a beam for scanning a three-dimensional space;
scan the three-dimensional space while fixing one of an azimuth angle and an elevation angle at which the beam is radiated in the three-dimensional space and changing the other based on the first angle change vector;
construct a first data set for input into an object tracking model based on a first received signal generated by reflection of the beam; and
input the first data set into the object tracking model and obtain object presence or absence information based on first output data of the object tracking model.

13. The apparatus of claim 12, wherein the object tracking model includes a model that predicts an object location based on the first data set and stores an azimuth angle and an elevation angle corresponding to the predicted object location as a criterion azimuth angle and a criterion elevation angle, and
the processor is configured to set the criterion azimuth angle and the criterion elevation angle as an origin, and set an operating mode to a second scan mode for tracking a location of the object in a surrounding space of the origin.

14. The apparatus of claim 13, wherein the processor is configured to:
determine a second angle change vector of the beam in the second scan mode for scanning the surrounding space;
scan the surrounding space while fixing one of the criterion azimuth angle and the criterion elevation angle at which the beam is radiated and changing the other based on the second angle change vector;
construct a second data set for input into the object tracking model based on a second received signal generated by reflection of the beam and the first output data ; and
input the second data set into the object tracking model and obtain object location information based on second output data of the object tracking model.

15. A computer-readable recording medium on which a program for causing the method according to claim 1 to be executed by a computer is recorded.
